(19) United States
(12) Patent Application Publication
(10) Pub. No.: US 2017/0370329 A1
(43) Pub. Date: Dec. 28, 2017

(54) VEHICULAR EGR COOLER

(71) Applicant: Hanon Systems, Daejeon (KR)

(72) Inventors: Tae Soo CHUN, Daejeon (KR); Jong Uk PARK, Daejeon (KR)

(73) Assignee: Hanon Systems, Daejeon (KR)

(21) Appl. No.: 15/544,997

(22) PCT Filed: Aug. 10, 2016
(86) PCT No.: PCT/KR2016/008771

§ 371 Date: Jul. 20, 2017

(30) Foreign Application Priority Data
Sep. 25, 2015 (KR) 10-2015-0136018
Sep. 25, 2015 (KR) 10-2015-0136063
Apr. 15, 2016 (KR) 10-2016-0046295

(51) Int. Cl. F02M 26/28; F02M 26/32; F28F 9/02; F28F 13/12

(52) U.S. Cl. CPC F02M 26/28; F28F 13/12; F02M 26/32; F28F 9/0229

(57) ABSTRACT

The present invention relates to an EGR cooler for a vehicle capable of increasing space utilization with a compact configuration, increasing an area in which exhaust gas exchanges heat with a cooling fluid, and reducing a pressure difference in exhaust gas at an exhaust gas inlet and an exhaust gas outlet since a plurality of gas tubes installed in a housing, respectively, are configured of a flat portion, a first bent portion, and a second bent portion and a length of the flat portion is longer than a height of the first bent portion and the second bent portion.

### TECHNICAL FIELD

The present invention relates to an EGR cooler, and more specifically, to an EGR cooler having improved cooling performance by allowing a gas tube disposed inside a housing to have a long flat portion in a longitudinal direction to increase an area in which exhaust gas exchanges heat with a cooling fluid.

### BACKGROUND ART

Generally, a large amount of harmful substances such as carbon monoxide, nitrogen oxide, and hydrocarbons are included in exhaust gas of a vehicle. In particular, an emission of the harmful substances like the nitrogen oxide increase as a temperature of an engine rises.

Today, exhaust gas regulations are being tightened in each country. In order to satisfy the tightened exhaust gas regulations for each country, various devices are installed in a vehicle to reduce the harmful substances like the nitrogen oxide among the exhaust gases.

In particular, since a vehicle equipped with a diesel engine has components of combusted fuel different from those of a vehicle equipped with a gasoline engine, the vehicle equipped with the diesel engine is equipped with devices such as a diesel particulate filter (DPF) and an exhaust gas recirculation (EGR) to satisfy the exhaust gas regulations by reducing the harmful exhaust gases like the nitrogen oxide.

In general, the DPF collects a particulate matter (PM) included in the exhaust gas into a filter and then injects fuel into an exhaust pipe at a front end of the filter to forcibly burn the particulate matter, thereby reducing the exhaust gas and regenerating the filter.

The exhaust gas recirculation (EGR) sucks some of the exhaust gases of the vehicle together with a mixer to lower a temperature of a combustion chamber, thereby reducing the emission of harmful substances such as nitrogen oxide and sulfur oxide.

Today, in addition, to cope with tightening of regulation on air pollution worldwide, an EGR cooler are applied together to lower a temperature of EGR gas. The exhaust gas introduced into the EGR cooler is cooled by coolant (cooling fluid) discharged through the engine.

As the related technology, there is Korean Patent No. 0748756 (Title: EGR cooler of EGR device for vehicle, Registration Date: Aug. 6, 2007).

The existing EGR cooler includes a cooler main body having both ends provided with a coolant inlet pipe and a coolant outlet pipe and a plurality of gas tubes arranged inside the cooler main body in parallel in a longitudinal direction, in which one side of the cooler main body is provided with a lead valve.

Accordingly, the coolant supplied through the coolant inlet pipe exchanges heat with the exhaust gas flowing through the gas tube in the cooler main body, and the coolant that has undergone the heat exchange is discharged through the coolant outlet pipe, thereby cooling the high-temperature exhaust gas.

By the way, in the EGR cooler in which the gas tube is formed of a U-bent type or an S-bent type among the existing EGR coolers, an exhaust gas inlet and an exhaust gas outlet are generally formed in one direction, and a length of the tube exchanging heat with the coolant in the housing is relatively short, and thus there is a problem in that the cooling performance deteriorates.

Further, in the case of the existing EGR cooler, as a pressure difference between the exhaust gas inlet and the exhaust gas outlet is large, the exhaust gas is not sufficiently cooled and thus there is a problem in that the engine performance deteriorates.

Further, in the case of the existing EGR cooler, as the length of the tube exchanging heat with the coolant is long, the EGR cooler may not be miniaturized, and there is a problem that a space for the EGR cooler is restrictive.

In addition, the existing I-flow tube type or U-bent type and S-bent type EGR cooler can not be applied when the exhaust gas inlet and the exhaust gas outlet are formed to be spaced apart from each other on the same plane, and thus have a limit in an applicable model.

### DISCLOSURE

### Technical Problem

An object of the present invention is to provide an EGR cooler for a vehicle capable of increasing space utilization with a compact configuration, increasing an area in which exhaust gas exchanges heat with a cooling fluid, and reducing a pressure difference in exhaust gas at an exhaust gas inlet and an exhaust gas outlet since a plurality of gas tubes installed in a housing, respectively, are configured of a flat portion, a first bent portion, and a second bent portion and a length of the flat portion is longer than a height of the first bent portion and the second bent portion.

Another object of the present invention is to provide an EGR cooler capable of improving fluidity of a cooling fluid introduced into a housing by adjusting a height of an end of a tube plate.

Still another object of the present invention is to provide an EGR cooler for a vehicle capable of being applied to a vehicle layout in which a housing is formed to correspond to an outer wall surface of a cylinder block positioned at an outer side of a water jacket of an internal combustion engine equipped in the vehicle to be disposed on the outer wall surface of the cylinder block and an exhaust gas inlet and an exhaust gas outlet are spaced apart from each other by a predetermined distance.

### Technical Solution

In one general aspect, an EGR cooler for a vehicle includes: a housing 100 provided with a cooling fluid inlet 110 and a cooling fluid outlet 120; a plurality of gas tubes 200 disposed in the housing 100 to form an exhaust gas channel and including a flat portion 210 extending along a longitudinal direction of the housing 100, a first bent portion 220 bent at one end of the flat portion 210, a second bent portion 230 bent at the other end of the flat portion 210 to face the first bent portion 220, a length L of the flat portion 210 being longer than a height H of the first bent portion 220 and the second bent portion 230; a tube plate 300 fixing the plurality of gas tubes 200; and a cover 400 coupled with the housing 100 at an outer side of the tube plate 300 and provided with an exhaust gas inlet 410 and an exhaust gas outlet 420.

The gas tube 200 may be formed so that the length L of the flat portion 210 is greater than 1 time and less than 20 times the height H of the first bent portion 220 and the second bent portion 230.

In the gas tube 200, the first bent portion 220 and the second bent portion 230 may be vertically bent at both ends of the flat portion 210 to be parallel with each other.

In the gas tube 200, the first bent portion 220 and the second bent portion 230 may be bent to form an obtuse angle α with respect to the flat portion 210 at both ends of the flat portion 210.

In the gas tube 200, a part of the first bent portion 220 may be bent so that the first bent portion 220 forms an obtuse angle β, and a part of the second bent portion 230 may be bent so that the second bent portion 230 forms the obtuse angle β while facing the first bent portion 220.

In the gas tube 200, the first bent portion 220 and the second bent portion 230 may be bent round to have a predetermined curvature R at both ends of the flat portion 210.

The cooling fluid inlet 110 may be formed at a position corresponding to a rounded region of the first bent portion 220 and the cooling fluid outlet 120 may be formed at a position corresponding to a rounded region of the second bent portion 230.

In the gas tube 200, the flat portion 210, the first bent portion 220, and the second bent portion 230 may be integrally formed.

The gas tubes 200 may be installed in a multi-stage manner so as to be spaced apart from each other by a predetermined distance along a height direction of the housing 100 within the housing 100 and may be installed in a multi-row manner so as to be spaced apart from each other by a predetermined distance along a width direction of the housing 100 within the same stage.

In the gas tube 200, a concave portion 211 may be formed on an outer side surface or an inner side surface of the flat portion 210, the first bent portion 220, and the second bent portion 230.

In the gas tube 200, a radiating fin 240 may be inserted into the flat portion 210 or into the first bent portion 220 and the second bent portion 230.

The gas tubes 200 may be installed in a multi-stage manner so as to be spaced apart from each other by a predetermined distance along the height direction of the housing 100 within the housing 100 and may be formed as a single tube 300 extending along a width direction of the housing 100 within the same stage.

The tube plate 300 may include a tube insertion hole 310 having both ends of the gas tube 200 inserted thereinto and a cooling fluid guide part 320 whose inner side surface of a position corresponding to the flat portion 210 of the gas tube 200 protrudes toward the flat portion 210.

A height D1 of the cooling fluid guide part 320 may be formed to be equal to or less than 0.85 times a distance D2 between a tube positioned at the outermost side of the tube plate 300 among the gas tubes 200 and the tube plate 300.

The tube plate 300 may have a turbulent flow forming part 330 formed on a side surface facing the gas tube 200 of the cooling fluid guide part 320.

The turbulent flow forming part 330 may be depressed in a dimple or a wave shape.

The housing may be formed to correspond to an outer wall surface of a cylinder block 10 positioned at an outer side of a water jacket 11 of an internal combustion engine equipped in the vehicle and thus may be disposed on the outer wall surface of the cylinder block 10.

The gas cover 400 may have the exhaust gas inlet 410 formed at one side thereof and the exhaust gas outlet 420 formed at the other side thereof, in a longitudinal direction, and the exhaust gas inlet 410 and the exhaust gas outlet 420 may be spaced apart from each other by a diameter R of at least one engine cylinder.

In the gas cover 400, a spaced distance S between the exhaust gas inlet 410 and the exhaust gas outlet 420 may be 1 to 3 times as large as the diameter R of the engine cylinder.

A spaced distance S between the exhaust gas inlet 410 and the exhaust gas outlet 420 may be formed to be 0.8 to 1.2 times as large as the length L of the flat portion 210 of the gas tube.

The cooling fluid inlet 110 of the housing 100 and the exhaust gas inlet 410 of the gas cover 400 may be formed to be opposite to each other in a longitudinal direction.

The EGR cooler for a vehicle may further include: a gasket 500 installed between the housing 100 and the tube plate 300.

The EGR cooler for a vehicle may further include: a sealing member 600 installed between the tube plate 300 and the gas cover 400.

The housing 100, the gasket 500, the tube plate 300, the sealing member 600, and the gas cover 400 may be coupled at an edge by a bolt.

The tube plate 300 and the gas cover 400 may be coupled by brazing.

### Advantageous Effects

Accordingly, the EGR cooler for a vehicle according to the exemplary embodiment of the present invention may improve the cooling performance of the EGR cooler as the gas tube disposed in the housing is formed to have the long flat portion in the longitudinal direction and thus the area in which the exhaust gas exchanges heat with the cooling fluid is increased and increases the space utilization with the compact configuration.

In addition, the EGR cooler for a vehicle according to the exemplary embodiment of the present invention may save the manufacturing costs and the manufacturing time of the EGR cooler as the plurality of tubes are easily mounted on the plate.

In particular, according to the EGR cooler for a vehicle according to the exemplary embodiment of the present invention, the tube plate protrudes toward the gas tube so that the space between the tube plate and the gas tube is filled to improve the fluidity so that the cooling fluid introduced into the housing is mostly guided toward the gas tube, thereby improving the cooling efficiency.

In addition, according to the EGR cooler for a vehicle according to an exemplary embodiment of the present invention, the turbulent flow forming part is formed on the tube plate in the dimple or the wave shape, thereby improving the cooling efficiency due to the turbulence of the coolant flow.

Further, according to the EGR cooler for a vehicle according to the exemplary embodiment of the present invention, the cooling fluid inlet and the cooling fluid outlet are disposed in the region in which the curved surface of the gas tube is formed to prevent the cooling fluid introduced into the housing from flowing into the bottom surface of the tube plate, thereby improving the fluidity.

Further, the EGR cooler for a vehicle according to the exemplary embodiment of the present invention may reduce the pressure difference in the exhaust gas at the exhaust gas inlet and the exhaust gas outlet to shorten the heat exchange time of the EGR cooler, thereby minimizing the degradation in the engine performance depending on the back pressure.

Further, the EGR cooler for a vehicle according to an exemplary embodiment of the present invention may be applied to the vehicle layout in which the exhaust gas inlet and the exhaust gas outlet are spaced apart from each other by the predetermined distance, thereby diversifying the applicable models.

### DESCRIPTION OF DRAWINGS

FIG. 1 is an exploded perspective view of an EGR cooler according to an exemplary embodiment of the present invention.

FIG. 2 is a front view of the EGR cooler for a vehicle according to the exemplary embodiment of the present invention.

FIG. 3 is a front view illustrating a state in which the EGR cooler according to the exemplary embodiment of the present invention is mounted at an outer side of an engine cylinder.

FIG. 4 is a perspective view illustrating a state where a gas tube is coupled with a tube plate according to an exemplary embodiment of the present invention.

FIG. 5 is a side perspective view of a partially cut state in a state in which the gas tube is coupled with the tube plate according to the exemplary embodiment of the present invention.

FIG. 6 is a side perspective view of a partially cut state in the state in which the gas tube is coupled with the tube plate according to the exemplary embodiment of the present invention.

FIGS. 7 to 10 are cross-sectional views of the gas tube according to various exemplary embodiments of the present invention.

FIG. 11 is a front view illustrating a state in which a housing is removed from the EGR cooler for a vehicle according to the exemplary embodiment of the present invention.

FIG. 12 is a diagram illustrating a result of analyzing a flow of a cooling fluid in the EGR cooler for a vehicle according to the exemplary embodiment of the present invention.

FIG. 13 is a front view of the existing EGR cooler for a vehicle.

FIG. 14 is a diagram illustrating the result of analyzing the flow of the cooling fluid in the EGR cooler for a vehicle according to the exemplary embodiment of the present invention of FIG. 13.

FIGS. 15 and 16 are plan views of the tube plate according to various exemplary embodiments of the present invention.

FIG. 17 is a perspective view illustrating a gas cover of an EGR cooler according to the exemplary embodiment of the present invention.

FIG. 18 is an exploded perspective view of the EGR cooler according to the exemplary embodiment of the present invention.

### BEST MODE

Hereinafter, an EGR cooler for a vehicle according to exemplary embodiments of the present invention will be described in detail with reference to the accompanying drawings.

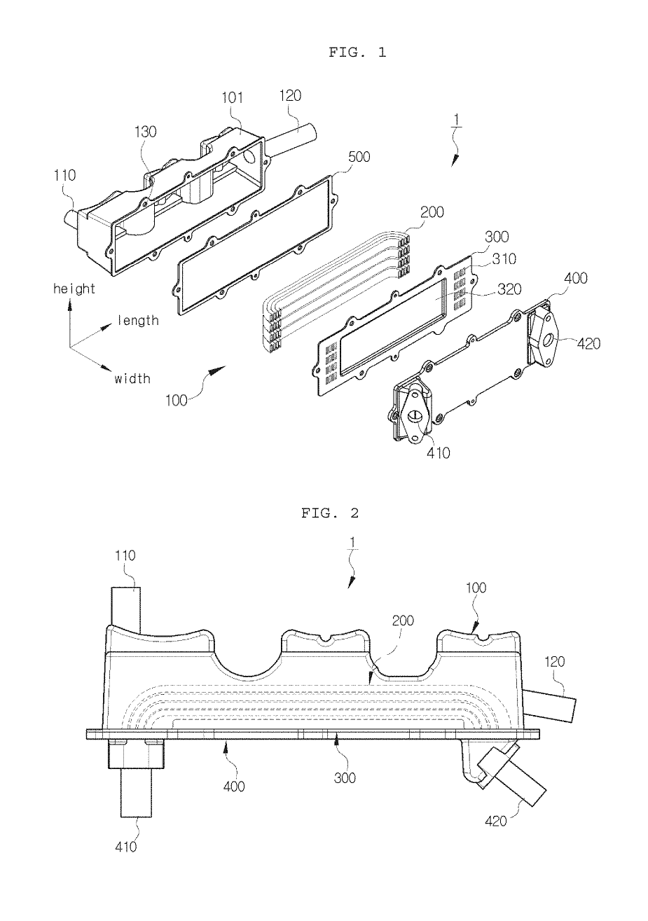

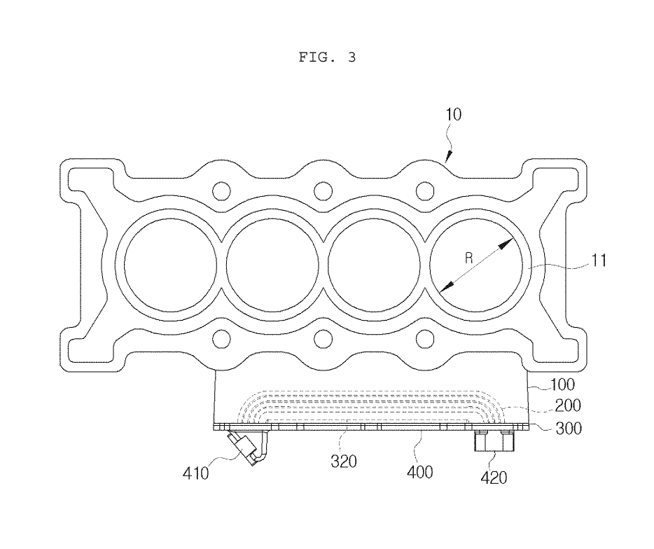

As illustrated in FIGS. 1 and 2, an EGR cooler 1 for a vehicle according to an exemplary embodiment of the present invention is configured to include a housing 100, a gas tube 200, a tube plate 300, and a gas cover 400.

The housing 100 is configured to include a cooling fluid inlet 110 and a cooling fluid outlet 120 and the inside of the housing 100 is formed with a space in which a cooling fluid introduced through the cooling fluid inlet 110 may be accommodated is formed in the housing 100. Here, as the cooling fluid, coolant is generally used, but other cooling fluids may be used.

The cooling fluid inlet 110 is formed in a part of a main body part 101. The coolant is introduced into the main body part 101 through the cooling fluid inlet 110.

The cooling fluid outlet 120 is formed in a part of the main body part 101. The coolant is discharged to the outside of the main body part 101 through the cooling fluid outlet 120.

FIGS. 1 and 2 illustrate that the cooling fluid inlet 110 and the cooling fluid outlet 120 are formed on different surfaces of the main body part 101, but the present invention is not limited thereto. That is, if necessary, the cooling fluid inlet 110 and the cooling fluid outlet 120 may be formed on the same surface of the main body part 101.

In the housing 100, a coupling hole 130 is formed at an edge of the main body part 101, and a gasket, a plate, a sealing member, and a cover which will be described below are fastened to the housing by a bolt. Although not necessarily limited thereto, it is preferable that at least two or more coupling holes 130 are formed at the edges of the main body part 110 in order to firmly fasten the gasket, the plate, the sealing member, and the cover, which will be described below, to the housing.

As illustrated in FIGS. 1 and 2, the housing 100 may have a rectangular parallelepiped shape whose one side is open or may also be formed in shapes corresponding to shapes of peripheral parts in consideration of the shapes of the peripheral parts. The housing 100 may be formed separately from an engine block and installed between an intake manifold and an exhaust manifold of an engine.

In this case, as illustrated in FIG. 3, the housing 100 is formed to correspond to an outer wall surface of a cylinder block 10 positioned at an outer side of a water jacket 11 of an internal combustion engine equipped in the vehicle, and is disposed to contact the outer wall surface of the cylinder block 10.

The housing 100 may be integrally formed with the engine block. In this case, as the cooling fluid inlet 110 and the cooling fluid outlet 120 do not have to be formed separately, it is possible to save manufacturing time and manufacturing costs of the housing 100 of the EGR cooler 1 by reducing the number of assembling processes and minimize a space in which the EGR cooler 1 is installed in an engine room of the vehicle.

Gas tubes 200 are arranged in a multi-stage and multi-row manner so as to be spaced apart from each other in a height direction within the housing 100, thereby forming an exhaust gas channel. That is, the exhaust gas flows through the plurality of gas tubes 200. In this case, the exhaust gas flowing in the housing 100 is cooled by exchanging heat with a cooling fluid in the housing 100.

As illustrated in FIG. 4, the gas tube 200 of the EGR cooler 1 for a vehicle according to an exemplary embodiment of the present invention is configured to include a first bent portion 220, a second bent portion 230, and a flat portion 210.

The flat portion 210 extends horizontally along a longitudinal direction of the housing 100, the first bent portion 220 is bent at one end of the flat portion 210 and the second bent portion 230 is bent at the other end of the flat portion 210.

At this point, the second bent portion 230 is formed to have the same length as the first bent portion 220 while facing the first bent portion 220.

That is, the gas tube 200 is generally formed in a ‘C’-letter form. In particular, when a length L of the flat portion 210 is formed to be longer than a height H of the first bent portion 220 and the second bent portion 230.

Therefore, in the gas tube 200, the length L of the flat portion 210 is longer than the height H of the first bent portion 220 and the second bent portion 230, such that an area in which the exhaust gas exchanges heat with the cooling fluid increases, thereby improving the cooling performance of the EGR cooler 1 and reducing the pressure difference in exhaust gas at the exhaust gas inlet 410 and the exhaust gas outlet 420.

In this case, the gas tube 200 is formed so that the length L of the flat portion 210 is formed to be greater than 1 time and less than 20 times the height H of the first bent portion and the second bent portion. That is, a ratio of the length L of the flat portion 210 to the height H of the first bent portion 220 and the second bent portion 230 is formed to be 20:1

In the gas tube 200, when the length L of the flat portion 210 is less than or equal to 1 time the height H of the first bent portion 220 and the second bent portion 230, the difference between the pressure of the exhaust gas introduced into the first bent portion 220 and the pressure of the exhaust gas discharged to the second bent portion 230 increases, which causes a problem in that the cooling efficiency deteriorates.

Further, when the length L of the flat portion 210 exceeds 20 times the height H of the first bent portion 220 and the second bent portion 230, the size of the EGR cooler 1 including the housing 100 is too large, and thus the housing 100 may not be integrally formed in the engine block. Even when the housing 100 is separately formed, there is a restriction on the space provided in the engine room, such that the problem in that the miniaturization of the EGR cooler 1 may not be achieved is caused.

The first bent portion 220 and the second bent portion 230 of the gas tube 200 may be bent round so as to have a predetermined curvature R at both ends of the flat portion 210.

Since the first bent portion 220 and the second bent portion 230 of the gas tube 200 are bent round to have a predetermined curvature R at one end and the other end of the flat portion 210, the exhaust gas introduced into the first bent portion moves to the flat portion 210 along the rounded surface and then is discharged to the outside along the rounded surface of the second bent portion so as to smoothly induce the flow of the exhaust gas as far as possible, thereby increasing a circulation speed of the exhaust gas to increase the cooling efficiency of the EGR cooler 1.

Although not necessarily limited thereto, the flat portion 210, the first bent portion 220, and the second bent portion 230 of each of the gas tubes 200 may be integrally formed of a metal material.

In this case, it is preferable that the curvature R of the first bent portion and the second bent portion formed at one end and the other end of the flat portion 210 is greater than 6 mm but less than 30 mm. (6 mm<R<30 mm). When the curvature R is equal to or less than 6 mm, there arises a problem that it is difficult to ensure the preparation of the tube. Further, when the curvature R is greater than 30 mm, the overall size of the tube 300 becomes larger and thus the overall size of the EGR cooler 1 including the housing 100 becomes larger, and thus there is a problem that it is difficult to ensure the installation position of the EGR cooler 1 separately installed in the engine block or the engine room.

Further, in the EGR cooler 1 for a vehicle according to the exemplary embodiment of the present invention, a radiating fin 240 may be inserted into the flat portion 210 of each tube or into the first bent portion and the second bent portion. Therefore, the EGR cooler 1 for a vehicle according to the exemplary embodiment of the present invention may increase the contact area of the exhaust gas passing through the inside of the housing 100 with the cooling fluid, thereby increasing a heat exchange amount.

Further, as illustrated in FIG. 2, the EGR cooler 1 for a vehicle according to the exemplary embodiment of the present invention is configured so that the cooling fluid inlet 110 of the housing 100 may be formed at a position corresponding to the rounded region of the first bent portion 220 and the cooling fluid outlet 120 may be formed at a position corresponding to the rounded region of the second bent portion 230.

As a result, the EGR cooler 1 for a vehicle according to the exemplary embodiment of the present invention may prevent the cooling fluid introduced into the housing 100 from moving to a bottom surface of the tube plate 300, thereby improving fluidity.

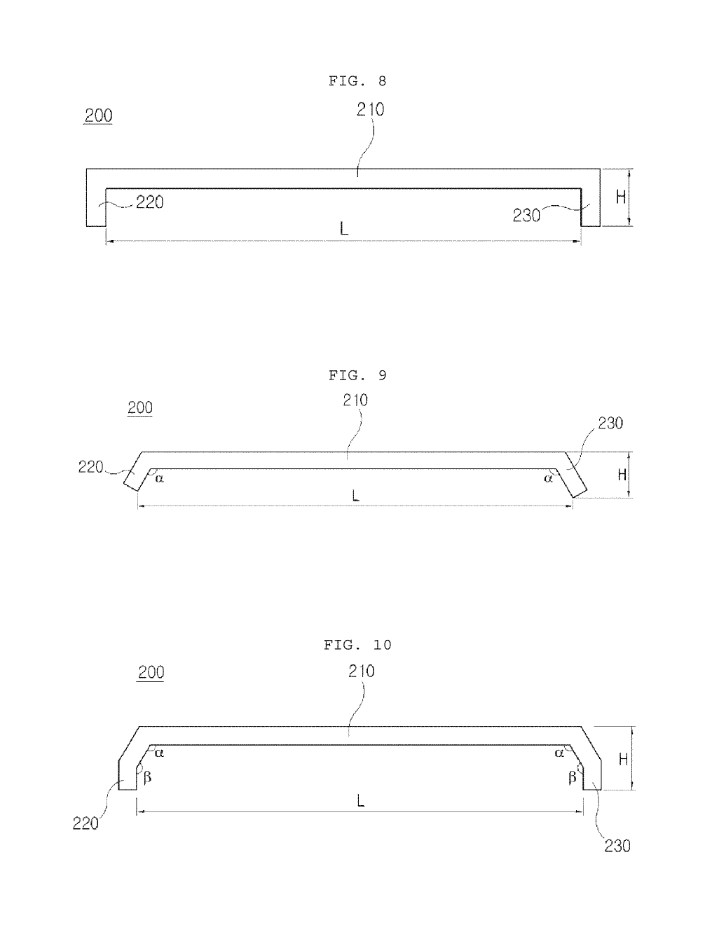

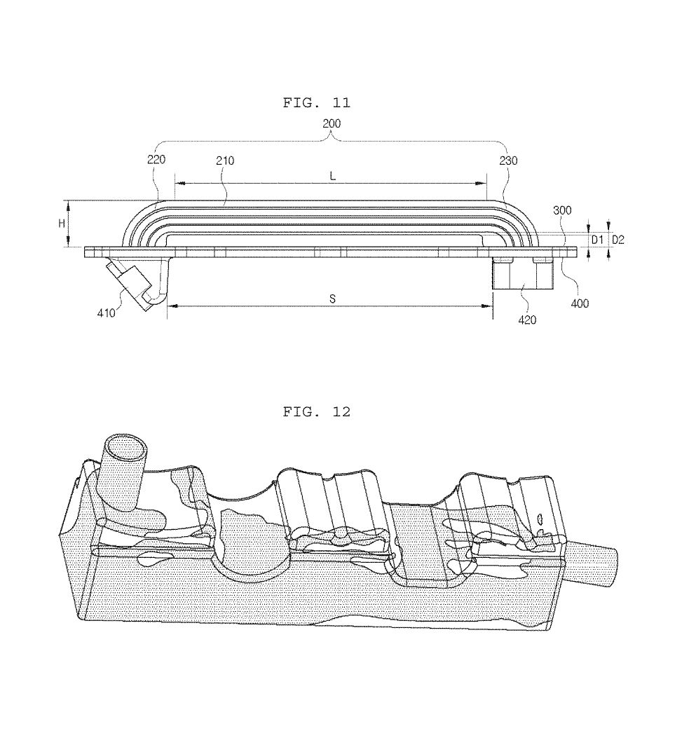

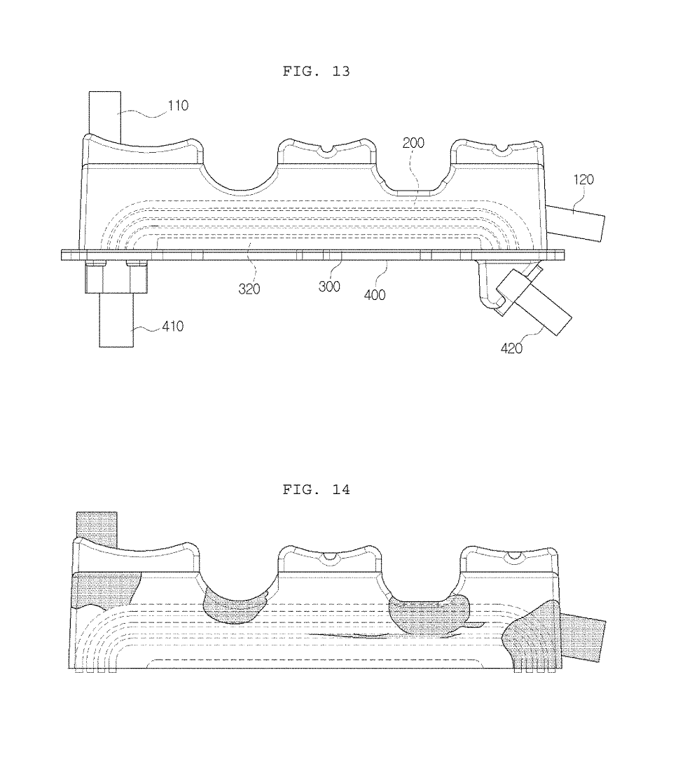

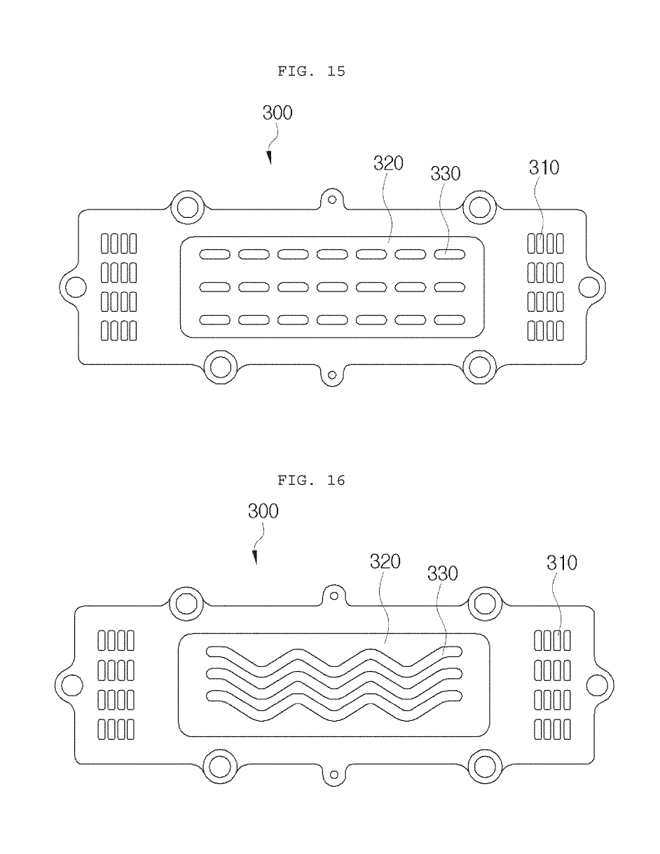

As illustrated in FIG. 8, according to another exemplary embodiment of the present invention, the first bent portion 220 and the second bent portion 230 of the gas tube 200 may be vertically bent at both ends of the flat portion 210 to be parallel to each other.

Therefore, as the first bent portion 220 and the second bent portion 230 of the gas tube 200 are vertically bent to form 90° with respect to the flat portion 210 at one end and the other end of the flat portion 210, the pressure difference between the exhaust gas inlet and the exhaust gas outlet is reduced, such that the cooling performance and the engine efficiency of the EGR cooler may be achieved and the first bent portion 220 and the second bent portion 230 may easily be coupled with a tube insertion hole 310 of the tube plate 300 to be described below.

As illustrated in FIG. 9, according to another exemplary embodiment of the present invention, the first bent portion 220 and the second bent portion 230 of the gas tube 200 may be bent at both ends of the flat portion 210 to form an obtuse angle α with respect to the flat portion 210.

That is, as the first bent portion 220 and the second bent portion 230 of the gas tube 200 are formed to have an obtuse angle α that is larger than 90° and smaller than 180° with respect to the flat portion 210, the flow of the exhaust gas flowing inside the gas tube 200 is smooth to increase the circulation of the exhaust gas, thereby improving the cooling efficiency of the EGR cooler.

As illustrated in FIG. 10, according to another exemplary embodiment of the present invention, a part of the first bent portion 220 may be bent so that the first bent portion 220 of the gas tube 200 forms an obtuse angle β and a part of the second bent portion 230 may be bent so that the second bent portion 230 forms the obtuse angle β while facing the first bent portion 220.

In the gas tube 200, a part of the first bent portion 220 and a part of the second bent portion 330 are bent, and thus the flow of the exhaust gas flowing in the gas tube 200 is smooth, such that the cooling efficiency of the EGR cooler may be improved and the first bent portion 220 and the second bent portion 230 may be easily coupled with the tube insertion hole 310 of the tube plate 300.

Further, the gas tubes 200 may be installed in a multi-stage manner so as to be spaced apart from each other by a predetermined distance along the height direction of the housing 100 within the housing 100 and may be installed in a multi-row manner so as to be spaced apart from each other by a predetermined distance along a width direction of the housing 100 within the same stage.

As the gas tubes 200 are arranged in the housing 100 in a multi-stage and multi-row manner along the height direction of the housing 100 and the width direction of the housing 100, the contact area of the exhaust gas passing through the inside of the main body part 101 of the housing 100 with the cooling fluid may be increased to increase the heat exchange amount.

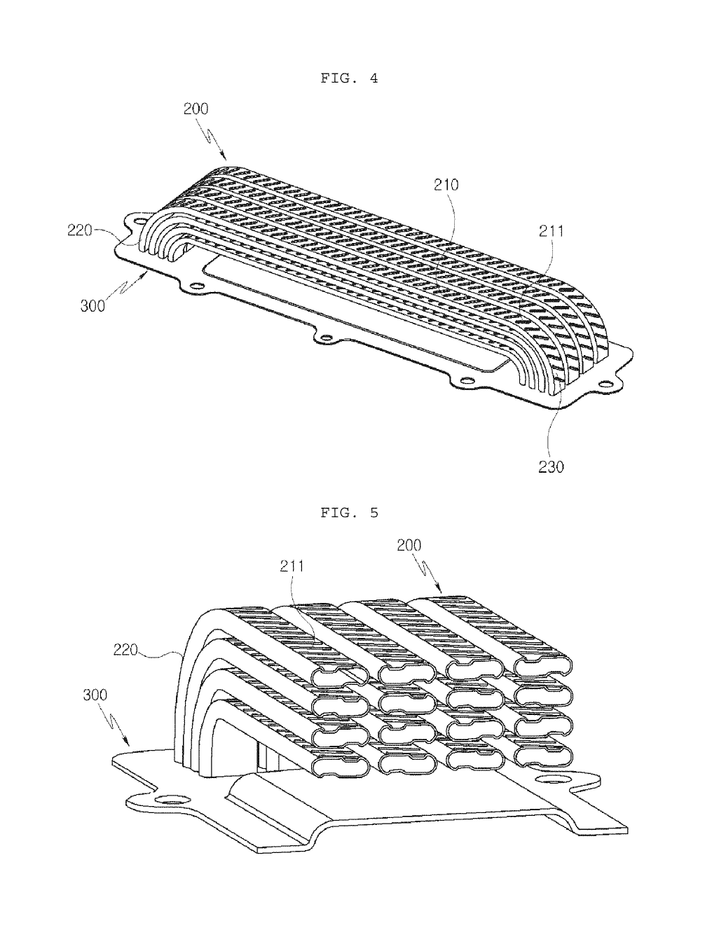

As illustrated in FIGS. 4 and 5, in the gas tube 200, a concave portion 211 may be formed on an outer side surface or an inner side surface of the flat portion 210, the first bent portion 220, and the second bent portion 230.

FIGS. 4 and 5 illustrate that a plurality of concave portions 211 are formed in a diagonal direction with respect to the width direction. However, the present invention is not necessarily limited thereto, and the shape and the direction of the concave portion 211 may be variously formed as needed.

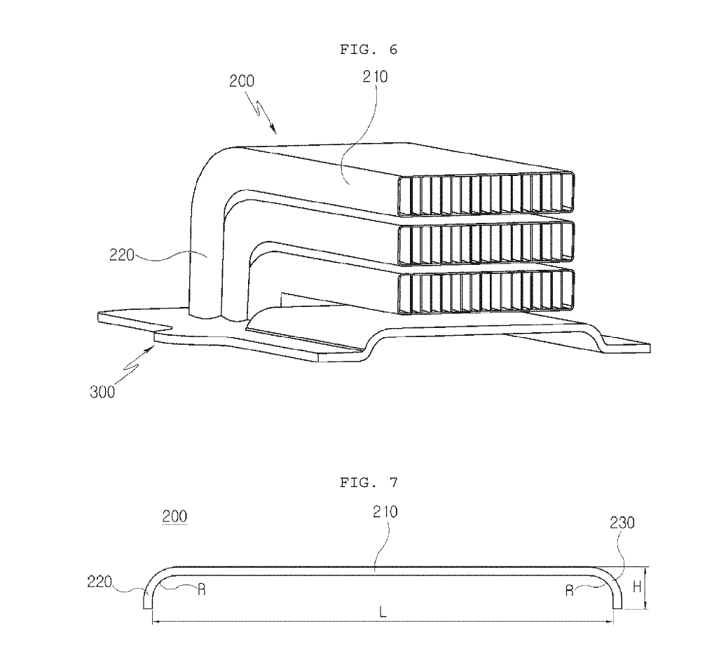

As illustrated in FIG. 6, the gas tubes 200 may be installed in a multi-stage manner so as to be spaced apart from each other by a predetermined distance along the height direction of the housing 100 within the housing 100 and may be formed as a single tube 300 formed to extend along the width direction of the housing 100 within the same stage.

As the gas tubes 200 are arranged in a multi-stage manner along the height direction of the housing 100 within the housing 100 and the single tube 300 extends along the width direction of the housing 100 within the same stage, the contact area of the exhaust gas passing through the inside of the main body part 101 of the housing 100 with the cooling fluid may be increased.

Meanwhile, the tube plate 300 has both ends of the gas tube 200 inserted thereinto and is formed to include tube insertion holes 310 corresponding to the number of gas tubes 200.

In particular, the tube plate 300 includes a cooling fluid guide part 320 whose inner side surface protrudes toward the flat portion 210 at a position corresponding to the flat portion 210 of the gas tube 200, thereby improving the fluidity of the cooling fluid flowing into the housing 100.

In other words, when there is no the cooling fluid guide part 320, some of the cooling fluid in the housing 100 may flow into a space between the tube positioned at an outermost side of the tube plate 300 among the gas tubes 200 and an inner surface of the tube plate 300 and then immediately be discharged to the cooling fluid outlet 120, such that some of the cooling fluid may be discharged without exchanging heat with the gas tube 200.

In order to prevent this, the EGR cooler 1 for a vehicle of the exemplary embodiment of the present invention has a cooling fluid guide part 320 formed between the gas tube 200 and the tube plate 300 so that most of the cooling fluid introduced through the cooling fluid inlet 110 may move along a path where the gas tube 200 is positioned and then may be discharged to the cooling fluid outlet 120, thereby improving the fluidity of the cooling fluid.

In this case, it is preferable that a height D1 of the cooling fluid guide part 320 is formed to be equal to or less than 0.85 times a distance D2 between the tube positioned at the outermost side of the tube plate 300 in the gas tube 200 and the tube plate 300.

When the cooling fluid guide part 320 is formed too high, the cooling fluid flowing in the housing 100 may hit the tube plate 300 and the gas tube 200 to generate noise, and therefore it is recommended to be formed at the same height as described above.

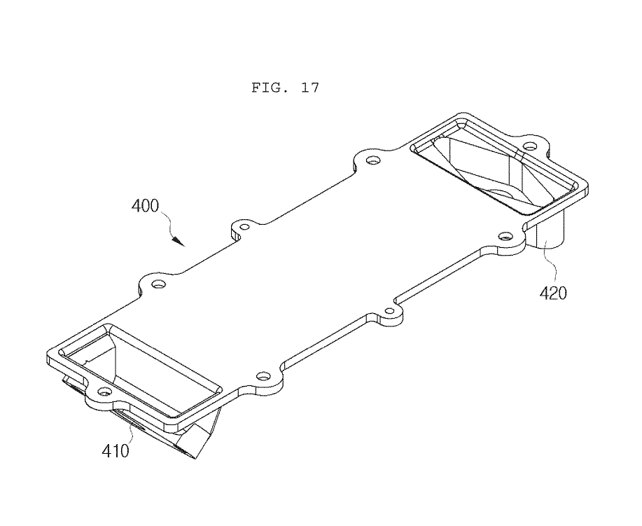

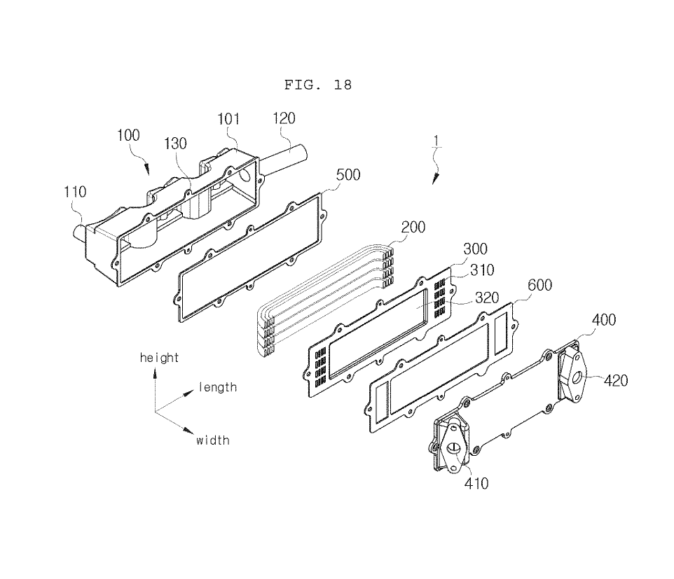

Further, as illustrated in FIGS. 15 and 16, the tube plate 300 may include a turbulent flow forming part 330 that is depressed on a side surface facing the gas tube 200 of the cooling fluid guide part 320 in a dimple or a wave shape.

Accordingly, the EGR cooler 1 according to the exemplary embodiment of the present invention uses the flow turbulence of the cooling fluid flowing in the housing by the turbulent flow forming part 330, thereby improving the cooling efficiency and reinforcing the rigidity of the tube plate 300.

The EGR cooler 1 for a vehicle according to the exemplary embodiment of the present invention is coupled to the housing 100 at the outer side of the tube plate 300 and further includes a gas cover 400 that has an exhaust gas inlet 410 formed on one side in a longitudinal direction thereof and an exhaust gas outlet 420 formed on the other side thereof.

The gas cover 400 is formed so that a spaced distance S between the exhaust gas inlet 410 and the exhaust gas outlet 420 is 1 to 3 times as larger as a diameter R of an engine cylinder, and as a result the EGR cooler 1 may be applied to the vehicle layout in which the exhaust gas inlet 410 and the exhaust gas outlet 420 are spaced apart from each other by a predetermined distance on the same plane, thereby diversifying the applicable model.

In this case, the exhaust gas inlet 410 and the exhaust gas outlet 420 may have an angle variously changed depending on the applicable model and the exhaust gas inlet 410 may be disposed on the same side as the cooling fluid inlet 110 of the housing 100 in the longitudinal direction and may also be disposed on an opposite side to the cooling fluid inlet 110 of the housing 100 in the longitudinal direction.

Further, in the EGR cooler 1 for a vehicle, the spaced distance S between the exhaust gas inlet and the exhaust gas outlet may be 0.8 to 1.2 times as larger as the length L of the flat portion 210 of the gas tube 200, such that the heat exchange area between the cooling fluid and the gas tube 200 may be secured above a certain area within the housing 100, thereby improving the cooling performance of the EGR cooler 1.

In addition, as illustrated in FIG. 18, the EGR cooler 1 for a vehicle according to another exemplary embodiment of the present invention may further include a gasket 500 or a sealing member 600.

The gasket 500 is installed between the housing 100 and the tube plate 300 to primarily prevent the cooling fluid from being leaked to the outside of the housing 100.

The gasket 500 may have a substantially rectangular plate shape and may be formed to correspond to a shape of an outer circumferential surface of the housing 100 and may be coupled to the housing 100 by a bolt.

The sealing member 600 is additionally installed between the tube plate 300 and the gas cover 400 to prevent exhaust gas introduced through the exhaust gas inlet 410 from being leaked. The sealing member 600 may be formed to correspond to the shape of the outer circumferential surface of the gas cover 400 and may be coupled between the tube plate 300 and the gas cover 400 by a bolt in the same manner as the gasket.

At this point, in the EGR cooler for a vehicle of the exemplary embodiment of the present invention, the tube plate 300 and the gas cover 400 may be coupled by brazing without the sealing member 600.

The present invention is not limited to the above-mentioned embodiments but may be variously applied, and may be variously modified by those skilled in the art to which the present invention pertains without departing from the gist of the present invention claimed in the claims.

[Detailed Description of Main Elements]

| | |
|---|---|
| 1: | EGR cooler |
| 100: | Housing |
| 101: | Main body part |
| 110: | Cooling fluid inlet |
| 120: | Cooling fluid outlet |
| 130: | Coupling hole |
| 200: | Gas tube |
| 210: | Flat portion, |
| 211: | Concave portion |
| 220: | First bent portion, |
| 230: | Second bent portion |
| 240: | Radiating fin |
| 300: | Tube plate |
| 310: | Tube insertion hole |
| 400: | Gas cover |
| 410: | Exhaust gas inlet, |
| 420: | Exhaust gas outlet |
| 500: | Gasket |
| 600: | Sealing member |

1.-25. (canceled)

26. An EGR cooler for a vehicle, comprising:
a housing provided with a cooling fluid inlet and a cooling fluid outlet;
a plurality of gas tubes disposed in the housing to form an exhaust gas channel and including a flat portion extending along a longitudinal direction of the housing, a first bent portion bent at one end of the flat portion, a second bent portion bent at the other end of the flat portion to face the first bent portion, a length L of the flat portion being longer than a height H of the first bent portion and the second bent portion;
a tube plate fixing the plurality of gas tubes; and
a cover coupled with the housing at an outer side of the tube plate and provided with an exhaust gas inlet and an exhaust gas outlet.

27. The EGR cooler for a vehicle of claim 26, wherein the gas tube is formed so that the length L of the flat portion is greater than 1 time and less than 20 times the height H of the first bent portion and the second bent portion.

28. The EGR cooler for a vehicle of claim 27, wherein in the gas tube, the first bent portion and the second bent portion are vertically bent at both ends of the flat portion to be parallel with each other.

29. The EGR cooler for a vehicle of claim 27, wherein in the gas tube the first bent portion and the second bent portion are bent to form an obtuse angle α with respect to the flat portion at both ends of the flat portion.

30. The EGR cooler for a vehicle of claim 29, wherein in the gas tube, a part of the first bent portion is bent so that the first bent portion forms an obtuse angle β, and a part of the second bent portion is bent so that the second bent portion forms the obtuse angle β while facing the first bent portion.

31. The EGR cooler for a vehicle of claim 27, wherein in the gas tube, the first bent portion and the second bent portion are bent round to have a predetermined curvature R at both ends of the flat portion.

32. The EGR cooler for a vehicle of claim 31, wherein the cooling fluid inlet is formed at a position corresponding to a rounded region of the first bent portion and the cooling fluid outlet is formed at a position corresponding to a rounded region of the second bent portion.

33. The EGR cooler for a vehicle of claim 26, wherein in the gas tube, the flat portion, the first bent portion, and the second bent portion are integrally formed.

34. The EGR cooler for a vehicle of claim 27, wherein the gas tubes are installed in a multi-stage manner so as to be spaced apart from each other by a predetermined distance along a height direction of the housing within the housing and are installed in a multi-row manner so as to be spaced apart from each other by a predetermined distance along a width direction of the housing within the same stage.

35. The EGR cooler for a vehicle of claim 34, wherein in the gas tube, a concave portion is formed on an outer side surface or an inner side surface of the flat portion, the first bent portion, and the second bent portion.

36. The EGR cooler for a vehicle of claim 35, wherein in the gas tube, a radiating fin is inserted into the flat portion or into the first bent portion and the second bent portion.

37. The EGR cooler for a vehicle of claim 27, wherein the gas tubes are installed in a multi-stage manner so as to be spaced apart from each other by a predetermined distance along the height direction of the housing within the housing and are formed as a single tube extending along a width direction of the housing within the same stage.

38. The EGR cooler for a vehicle of claim 26, wherein the tube plate includes a tube insertion hole having both ends of the gas tube inserted thereinto and a cooling fluid guide part whose inner side surface of a position corresponding to the flat portion of the gas tube protrudes toward the flat portion.

39. The EGR cooler for a vehicle of claim 38, wherein a height D1 of the cooling fluid guide part is formed to be equal to or less than 0.85 times a distance D2 between a tube positioned at the outermost side of the tube plate among the gas tubes and the tube plate.

40. The EGR cooler for a vehicle of claim 38, wherein the tube plate has a turbulent flow forming part formed on a side surface facing the gas tube of the cooling fluid guide part.

41. The EGR cooler for a vehicle of claim 40, wherein the turbulent flow forming part is depressed in a dimple or a wave shape.

42. The EGR cooler for a vehicle of claim 26, wherein the housing is formed to correspond to an outer wall surface of a cylinder block 10 positioned at an outer side of a water jacket 11 of an internal combustion engine equipped in the vehicle and thus is disposed on the outer wall surface of the cylinder block 10.

43. The EGR cooler for a vehicle of claim 42, wherein the gas cover has the exhaust gas inlet formed at one side thereof and the exhaust gas outlet formed at the other side thereof, in a longitudinal direction, and the exhaust gas inlet and the exhaust gas outlet are spaced apart from each other by a diameter R of at least one engine cylinder.

44. The EGR cooler for a vehicle of claim 43, wherein in the gas cover, a spaced distance S between the exhaust gas inlet and the exhaust gas outlet is 1 to 3 times as large as the diameter R of the engine cylinder.

45. The EGR cooler for a vehicle of claim 43, wherein a spaced distance S between the exhaust gas inlet and the exhaust gas outlet is formed to be 0.8 to 1.2 times as large as the length L of the flat portion of the gas tube.

46. The EGR cooler for a vehicle of claim 26, wherein the cooling fluid inlet of the housing and the exhaust gas inlet of the gas cover are formed to be opposite to each other in a longitudinal direction.

47. The EGR cooler for a vehicle of claim 26, further comprising:
a gasket 500 installed between the housing and the tube plate.

48. The EGR cooler for a vehicle of claim 47, further comprising:
a sealing member installed between the tube plate and the gas cover.

49. The EGR cooler for a vehicle of claim 48, wherein the housing, the gasket 500, the tube plate, the sealing member, and the gas cover are coupled at an edge by a bolt.

50. The EGR cooler for a vehicle of claim 26, wherein the tube plate and the gas cover are coupled by brazing.
